(19) United States
(12) Patent Application Publication
(10) Pub. No.: US 2006/0286280 A1
(43) Pub. Date: Dec. 21, 2006

(54) Compositions containing protein and DAG oil and methods for making them

(76) Inventors: Lisa L. Bradford, Decatur, IL (US); W. Russell Egbert, Decatur, IL (US); Thomas V. Gottemoller, Mount Zion, IL (US); Dennis Branin Lane, Lafayette, CO (US); MaryJayne Mount, Redondo Beach, CA (US)

Correspondence Address: KIRKPATRICK & LOCKHART NICHOLSON GRAHAM LLP;HENRY W. OLIVER BUILDING, 535 SMITHFIELD STREET, PITTSBURGH, PA, 15222, US

(21) Appl. No.: 11/449,204

(22) Filed: Jun. 8, 2006

Related U.S. Application Data
(60) Provisional application No. 60/688,849, filed on Jun. 9, 2005.

(51) Int. Cl. A23J 1/00

(52) U.S. Cl. 426/656

(57) ABSTRACT

Methods are provided for making dried protein-diacylglycerol oil (DAG oil) compositions, for incorporation into food products. A protein-containing ingredient in liquid form is combined with DAG oil, and the mixture is then spray-dried. Dried protein-DAG oil compositions are also provided.

### CROSS-REFERENCE TO RELATED APPLICATIONS

This application claims the benefit of U.S. Provisional Application No. 60/688,849, filed on Jun. 9, 2005, the entire teachings of which are incorporated herein by reference.

### FIELD

The invention relates to dried compositions of protein and diacylglycerol oil.

### BACKGROUND

The primary energy sources available from the typical foods, drinks, and/or supplements consumed by most human populations are sugars and fats. In most diets in the more industrialized countries, high surplus calories are often sourced from higher-fat foods, such as triacylglycerol oil (TAG oil). TAG oil is typically a vegetable oil, but not limited to, corn oil, peanut oil, safflower oil, sunflower oils, and soybean oil. Much modern medical research suggests that high fat/lipid diets, particularly those high in cholesterol, trans and saturated fatty acids, and triglycerides, can contribute significantly to the development of many diseases, and particularly heart disease, atherosclerosis, high blood pressure, and other cardiovascular diseases. In addition, other disease states, such as cancer, and the general tendency toward obesity in certain populations, are at least in part traceable to diets containing excess fats/lipids.

An alternate source of fat that can provide the gustatory benefits discerned in typical high fat foods (richness, fatty savor, pleasant mouth feel, and other organoleptic characteristics typically enjoyed in higher fat foods) is diacylglycerol oil (DAG oil). Diglyceride oils are generally described in numerous patents, including, for example, U.S. Pat. Nos. 5,160,759; 6,287,624; and laid-open Japanese patents JP-A 63-301754; JP-A 5-168142; and JP-A 60180. In particular, U.S. Pat. No. 5,160,759 describes oil-in-water emulsions comprising diglyceride oils. U.S. Pat. No. 6,361,980 discloses an enzyme-based process useful for the production of such diglycerides. These patents also demonstrate the health benefits that can be achieved by eating diacylglycerol-containing food products.

Diacylglycerols are naturally occurring compounds found in many edible oils. Through interesterification, an edible oil containing increased level of diacylglycerols has been produced that shows different metabolic effects compared to conventional edible oils. Differences in metabolic pathways between 1,3 diacylglycerol and either 1,2 diacylglycerol or triglycerides allow a greater portion of fatty acids from 1,3 diacylglycerol to be burned as energy rather than being stored as fat. Clinical studies have shown that regular consumption of diacylglycerol oil as part of a sensible diet can help individuals to manage their body weight and body fat. In addition, metabolism of 1,3 diacylglycerol reduces circulating postmeal triglycerides in the bloodstream. Since obesity and elevated blood lipids are associated as risk factors for chronic diseases including cardiovascular disease and Type II diabetes, these lifestyle-related health conditions may be impacted in a beneficial manner with regular consumption of diacylglycerol oils.

Proteins have been formulated into a large variety of commonly consumed food products. These proteins can be used simply for protein fortification, for the functional benefits that they bring to a food system, or for the health benefits such as those associated with soy protein. Nutritional bar and beverages are good examples of were proteins are used to provide the protein nutrient to a food system but can also provide functional benefits, some of these characteristics include: fat emulsification, structural and textural integrity and water binding.

The FDA health claim for soy protein that was issued on Oct. 26, 1999 has had a significant impact on the use of soy proteins in food applications. Numerous new food products have been developed in an attempt to take advantage of the high profile of soy foods created in the marketplace as a result of the health claim. In many of these applications, isolated soy proteins or soy protein concentrate have been required in order to achieve the desired soy protein content given the reference serving size for the food item. The soy protein health claim allows food manufacturers to make a health claim related to the heart health benefits of soy protein on their food packaging. The FDA provided the following two model statements when they issued the health claim for soy protein that can be used by U.S. food manufacturers on their packaging: “Diets low in saturated fat and cholesterol that include 25 grams of soy protein a day may reduce the risk of heart disease. One serving of (name of food product) provides (quantity of soy protein) grams of soy protein,” or “25 grams of soy protein a day, as part of a diet low in saturated fat and cholesterol, may reduce the risk of heart disease. A serving of (name of food product) supplies (quantity of soy protein) grams of soy protein.” In order for food products to meet the soy protein health claim, a serving of the food must contain a minimum of 6.25 grams of soy protein; be low in fat, saturated fat and cholesterol; and also meet the general health claim requirements for foods that make any health claim.

### SUMMARY

Methods are described herein for making a protein composition containing DAG oil, where the DAG oil is combined with a protein-containing ingredient in liquid form, and the mixture is then spray-dried. Methods are also described for making a protein composition containing DAG oil, where a protein powder is hydrated, the DAG oil is combined with a protein-containing ingredient in liquid form, and the mixture is then spray-dried. Compositions are also provided that contain protein and DAG oil.

A method is provided for making a protein composition containing DAG oil, including the steps of combining a liquid protein-containing ingredient and a DAG oil to form a liquid protein-oil mixture, and then spray-drying the liquid protein-oil mixture to make a protein composition containing DAG oil. A method is also provided for making a protein composition containing DAG oil, including the steps of hydrating a protein powder to make a liquid protein-containing ingredient, combining the liquid protein-containing ingredient and a DAG oil to form a liquid protein-oil mixture, and then spray-drying the liquid protein-oil mixture to make a protein composition containing DAG oil. The protein powder can be hydrated under conditions of high shear. The hydration can occur over about 10 minutes to about 15 minutes. Either of these methods can include the additional steps of pasteurizing the liquid protein-oil mixture before spray-drying, or flash cooling the pasteurized liquid protein-oil mixture under vacuum before spray-drying.

Also provided is a protein-DAG oil composition made by the above methods, and a composition consisting essentially of protein and DAG oil.

In any of the above methods or compositions, the protein can be an animal protein or a plant protein. The animal protein can be, for instance, milk protein, caseinate, whey protein, milk powders, buttermilk solids, or egg protein. The plant protein can be, for instance, soy, canola, pea, wheat, potato, corn, sesame, sunflower, cottonseed, copra, palm kernel, safflower, linseed, peanut, lupin, or oat protein. The protein can be mixtures of any of these proteins.

The protein-DAG oil composition can contain up to about 50% DAG oil by weight, about 20% to about 40% DAG oil by weight, or about 30% DAG oil by weight. The protein-DAG oil composition can contain 50% or more protein by weight, about 50% to about 80% protein by weight, or about 60% protein by weight.

It should be understood that this invention is not limited to the embodiments disclosed in this Summary, and it is intended to cover modifications that are within the spirit and scope of the invention, as defined by the claims.

### BRIEF DESCRIPTION OF THE DRAWINGS

FIG. 1 is a schematic diagram showing the soy protein manufacturing process.

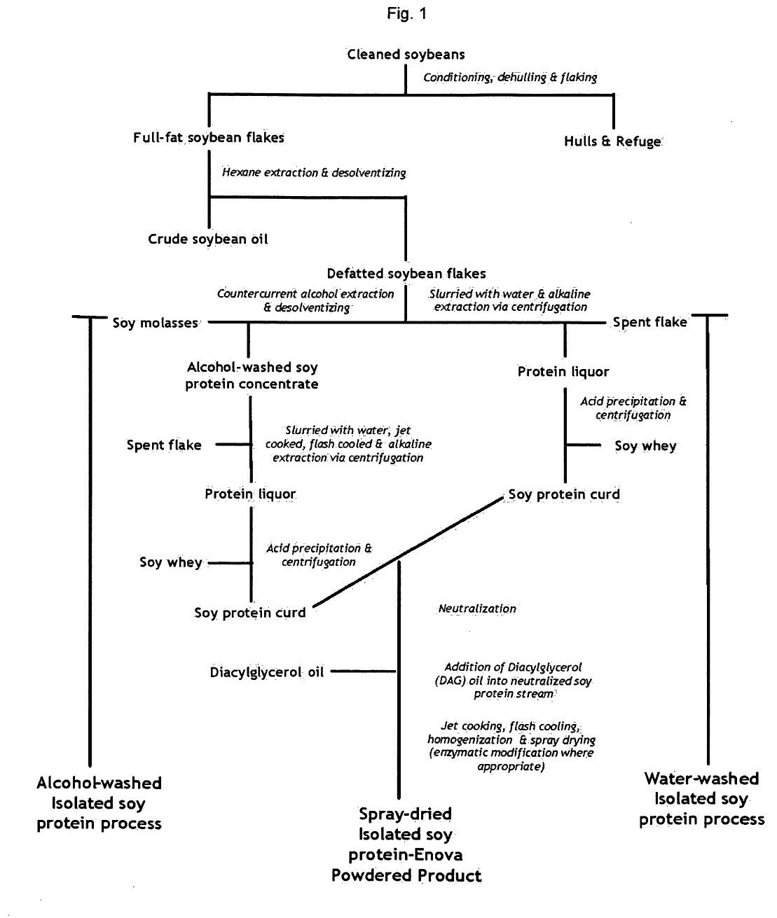

### DETAILED DESCRIPTION

Other than in the examples herein, or unless otherwise expressly specified, all of the numerical ranges, amounts, values and percentages, such as those for amounts of materials, elemental contents, times and temperatures of reaction, ratios of amounts, and others, in the following portion of the specification and attached claims may be read as if prefaced by the word “about” even though the term “about” may not expressly appear with the value, amount, or range. Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains error necessarily resulting from the standard deviation found in its underlying respective testing measurements. Furthermore, when numerical ranges are set forth herein, these ranges are inclusive of the recited range end points (i.e., end points may be used). When percentages by weight are used herein, the numerical values reported are relative to the total weight.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10. The terms “one,” “a,” or “an” as used herein are intended to include “at least one” or “one or more,” unless otherwise indicated.

Any patent, publication, or other disclosure material, in whole or in part, that is said to be incorporated by reference herein in its entirety is incorporated herein only to the extent that the incorporated material does not conflict with existing definitions, statements, or other disclosure material set forth in this disclosure. As such, and to the extent necessary, the disclosure as explicitly set forth herein supersedes any conflicting material said to be incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

As described herein, dried compositions containing protein and DAG oil are produced by combining protein in liquid form and DAG oil to form a mixture, which is then dried. Methods for making the compositions are also provided, and include combining a liquid protein-containing ingredient and a DAG oil to form a liquid protein-oil mixture, and then spray-drying the liquid protein-oil mixture. The liquid protein-containing ingredient can be any liquid which contains sufficient protein such that, when DAG oil is added and the mixture is spray-dried, a dried composition containing protein and DAG oil is produced. The liquid protein-containing ingredient can be, for instance, the protein stream from soybean or milk processing, or it can be hydrated protein powder.

Fatty acids in the body arise either from biosynthesis from acetyl-CoA or from breakdown of fats and phospholipids. Free fatty acids are rarely found in the body. Fatty acids can be saturated (no double bonds) or unsaturated (contain double bonds). Unsaturated fatty acids of biological origin predominantly contain cis-double bonds. Mammals are unable to synthesize some fatty acids, making these fatty acids essential components of their diet. Some exemplary fatty acid lengths that can be used to make TAG and DAG oils are, but not limited to, short (e.g., 8-12 carbon atoms), medium (e.g., 13-17 carbon atoms) or long (e.g., 18-22 carbon atoms) chain fatty acids with no or up to six double bonds. Exemplary non-limiting fatty acids are lauric acid (12 carbon atoms, no double bonds), myristic acid (14 carbon atoms, no double bonds), palmitic acid (16 carbon atoms, no double bonds), stearic acid (18 carbon atoms, no double bonds), linoleic acid (18 carbon atoms, 2 double bonds), alpha-linolenic acid (18 carbon atoms, 3 double bonds), eicosapentaenoic acid (20 carbon atoms, 5 double bonds (EPA)) and docosahexanoic acid (22 carbon atoms, 6 double bonds).

DAG oils can be made with the same fatty acids as listed above, with two fatty acids esterified onto the glycerol backbone in either the 1,3-configuration or the 1,2-configuration. In contrast, TAG oils comprise three fatty acids attached to a glycerol backbone. DAG oils are generally described in numerous patents, including, but not limited to U.S. Pat. Nos. 5,160,759; 6,287,624, which are incorporated herein by reference in their entirety; and laid-open Japanese patents JP-A 63-301754; JP-A 5168142; and JP-A 60180.

DAG molecules are naturally occurring and are found in many edible oils. DAG oil typically contains greater than 80% diacylglycerol, with approximately 15% triacylglycerol, 1% monoacylglycerol and less than 1% emulsifiers (polyglycerol esters of fatty acids) and antioxidants (ascorbyl palmitate and tocopherol). Typical formulations of TAG oil comprise from 90% to 99% TAG and from 1% to 10% DAG by weight. Through interesterification, edible oils containing increased levels of diacylglycerols have been produced that show different metabolic effects compared to traditional TAG oils. Typically, the diacylglycerol component of a DAG oil comprises about 70% 1,3-diacylglycerol and about 30% 1,2-diacylglycerol. Without intending to be limited by any interpretation, it is believed that the 1,3-isomer provides the beneficial effects on fat metabolism.

1,3-Diacylglycerol appears to be metabolized differently than either 1,2-diacylglycerol or triacylglycerols, wherein the body preferentially burns 1,3-diacylglycerol for energy via β-oxidation rather than storing it as fat. Yasukawa et al., “Diacylglycerols,” in Diacylglycerol Oil, Katsuragi et al., eds., AOCS Press, pp. 1-15 (2004). 1,3-Diglycerides, the primary component of DAG oil, are converted into 1- or 3-monoglycerides by lipases in the small intestine. Clinical studies have shown that regular consumption of DAG oil as part of a balanced diet may help individuals to manage their body weight and body fat. This may be achieved by enhancing dietary fat metabolism, lowering elevated blood lipids (particularly triglycerides), and controlling body fat. There does not appear to be any adverse effects from single dose or long term consumption of DAG oils. DAG oil also does not appear to affect the absorption of fat-soluble vitamins in the diet. Watanabe et al., Ann. Nutr. Metab. 45:259-64 (2001).

In Japan and the United States, DAG oil is used as cooking oil, as an ingredient for margarine, dressings, canned tuna, some baked goods, health bars, soups, gravies, etc. DAG oil has been marketed as Enova® (a trademark of ADM Kao LLC, Decatur, Ill.) and Econa® (a trademark of Kao Corp., Tokyo, Japan) brands in the United States and overseas, which are highly unsaturated edible oils made from all natural soybean and canola oil. Enova® contains greater than 80% diacylglycerol. The diacylglycerol is esterified with predominantly unsaturated fatty acids, including oleic, linoleic and linolenic fatty acids.

Diacylglycerides (i.e., DAG oil) can be produced in several ways. For example, they can be prepared either by interesterifying an oil or fat with glycerol or by esterifying a fatty acid with glycerol, or by esterifying the hydroxyl groups at the 1- and 2-positions or at the 1- and 3-positions of glycerol with fatty acids. Typically, DAG oil is manufactured from natural edible plant oils such as soybean, canola (rapeseed) or corn oil and is composed largely of randomized diacylglycerols. The interesterification reactions may be effected chemically with a hydroxide catalyst of an alkali metal or and alkaline earth metal, or enzymatically, such as by digestion of a triacylglycerol by triacylglycerol lipase. Another non-limiting example is to esterify fatty acids to glycerol in the presence of a specific lipase, such as Lipozyme RM IM (“Rhizomucor miehei lipase, immobilized on resin,” available from Novozymes A/S, Bagsvaerd, Denmark) or other 1,3-regioselective lipases. Lipozyme RM IM is adsorbed on a macroporous resin and is particularly useful for the catalysis of esterification and interesterification reactions.

DAG oils suitable for use in various non-limiting embodiments of the invention described herein are those in which the constituent fatty acids typically comprise C8-24 saturated and unsaturated fatty acids, with no greater than 5% saturated fatty acids. The number of carbon atoms in fatty acid residues are preferably (but not limited to) 8 to 24 carbon atoms, particularly 16 to 22 carbon atoms. In one typical embodiment, the main constituent fatty acids of DAG-oil are oleic (C18:1), linoleic (18:2), and/or alpha-linolenic (C18:3) acids, present as 1,3- and 1,2-diacylglcyerols at a ratio of 7:3. These fatty acids are only exemplary and are not meant to be limiting in any way. According to various non-limiting embodiments, a single DAG oil or blends of two or more DAG oils with varying fatty acid compositions may be used with the invention. “DAG oil,” as used herein, is therefore intended to mean either oil containing a single DAG oil constituent, or an oil containing multiple DAG oil constituents.

Oxidative stability of the DAG oil can be optimized by inclusion of antioxidants and other formulation enhancements, including, but not limited to, tocopherols (alpha, beta, gamma, and/or delta), vitamin C palmitate, polyglycerol esters of fatty acids, phytosterols, and/or phytostanols.

In one embodiment, the DAG oil component comprises 1,3-diglycerides in an amount from about 5% to about 50% by weight of the composition, more preferably at least about 20 to about 30% by weight.

Protein from any available source can be used in the compositions. For instance, the protein can be a plant protein such as, but not limited to, soy, canola, pea, wheat, potato, corn, sesame, sunflower, cottonseed, copra, palm kernel, safflower, linseed, peanut, lupin, and oat protein, or mixtures of any of these. The protein can also be an animal-based protein, such as, but not limited to, milk protein, caseinate, whey protein, buttermilk solids, milk powders, egg protein, or the like, and mixtures thereof.

For instance, a protein isolate such as PRO-FAM®825, PRO-FAM®873, or PRO-FAM® 892 (Archer Daniels Midland Company, Decatur, Ill., USA) can be used. PRO-FAM®825, PRO-FAM®873 and PRO-FAM®892 are soy protein isolates that contains about 90% protein (N x 6.25, min., %, on a moisture-free basis). Other sources of protein can also be used. The protein source used should have a protein content sufficient to produce a composition having a protein content as described herein.

Hydrated protein powders are prepared using art-recognized methods, typically using high speed mixing, shear, and/or homogenization. For instance, a soluble food protein can be hydrated by slowly adding the protein to an aqueous solution under conditions of high shear. Once the protein is dispersed in the solution, agitation should be minimized to avoid incorporation of air and formation of foam. The protein should be mixed long enough to ensure full hydration, e.g., 10-15 minutes. The DAG oil is added to the aqueous phase and the mixture homogenized. The mixture is then spray-dried. The protein can be hydrated protein powder, or the protein can be taken from a commercial protein manufacturing process, e.g., a commercial soymilk, soy protein or protein concentrate manufacturing process. The composition can also be made as part of a milk protein or caseinate manufacturing process.

The mixture can be dried, e.g., it can be allowed to stand until dried, or it can be fed into a continuous drier or batch drier such as a turbotray drier, direct-heat rotary drier, drum drier, belt drier, spray drier, fluid bed drier and similar industrial driers well known to those skilled in chemical technology (see, e.g., “Drying” in Kirk-Othmer's Encyclopedia of Chemical Technology, vol. 8, pages 91-112, 1979). Alternatively, the dehydration of the mixture can be carried out by treating it with a very small volume of a pharmaceutically-acceptable and non-toxic volatile, water-miscible solvent in which the ingredients are insoluble. Once the material is dried, it can be optionally ground to a preferred range of particle sizes.

Spray drying is a widely used industrial process and allows for the continuous production of dry solids (e.g., agglomerates, granules, powders) from liquid feedstocks (e.g., pumpable solution, emulsions, suspensions). The process is often used where the finished product must meet specifications regarding residual moisture content, particle size and shape, and bulk density.

In spray drying, the liquid feedstock is atomized, either by rotary or nozzle atomizers, into droplets, which are dried by exposure to warm air in a drying chamber. The temperature and airflow conditions within the drying chamber control the moisture evaporation and the particle size of the finished product. The mode of contact between the atomized particles and the drying air can also be used to control the evaporation rate and the temperature of the product. Modes of contact can include co-current, counter-current, and mixed flow. In a co-current drying chamber, the particles and the drying air move through the chamber in the same direction, and the particles therefore are initially exposed to air of higher heat, which cools as the particles move through the chamber. This method is often used for heat-sensitive products. In a counter-current chamber, the drying air and the particles move in opposite directions, and the particles therefore are exposed to air of increasing temperature as they move through the chamber. This method is used for products which require higher heat, and/or which are not heat-sensitive. In a mixed flow chamber, the particles meet both co-current and counter-current flows of air.

The drying process is controlled to ensure the desired level of residual moisture in the finished product. The desired final moisture content of the finished product will be dictated by various factors such as particle size, storage life, intended use, etc., and control of the moisture content is well within the skill of those of ordinary skill in the art.

For instance, the protein-DAG oil composition can be produced in the commercial isolated soy protein manufacturing process or the functional soy protein concentrate manufacturing process through the addition of DAG oil to the neutralized protein stream, prior to or after jet-cooking, followed by flash-cooling, homogenization and spray-drying steps. Similarly, addition of the DAG oil can be made during the manufacturing processes for producing the various milk proteins, such as whey protein concentrate, non-fat dry milk, caseinates, whey protein isolates, dried buttermilk solids and spray-dried milk proteins. Other animal and plant based food protein systems that could be used to produce the protein-DAG spray-dried product could include proteins from canola or rape seed, pea, wheat, egg, potato, corn, sesame, sunflower, cottonseed, copra, palm kernel, safflower, linseed, peanut, lupin, oat as well as other soy derived protein sources.

The spray-dried product can also be made at a spray-drying facility through the use of food protein powders and liquid DAG oil. This process involves the hydration of a highly soluble food protein by first slowly adding the appropriate protein to water under conditions of high shear. Once dispersed, agitation should be minimized in order to avoid air incorporation and limit foam formation. The protein should be mixed sufficiently long enough, typically 10-15 minutes, to ensure that the protein is fully hydrated. Once the protein is hydrated, the DAG oil is incorporated. The product is then homogenized, thermally heat treated (such as through pasteurization) and spray-dried. The product can also be flash cooled under vacuum to removed unwanted volatile flavors and odors prior to spray-drying.

The protein-DAG oil composition can also be ground and screened. The composition can be agglomerated or can also be compressed into pellets, if desired. The composition is then packaged.

According to other embodiments, any of the methods described herein may further include the steps of placing the composition in a container which may be configured for shipping. The methods may further comprise associating indicia with the container, such as, for example, placing graphical, written, or numerical indicia on the container. The indicia may be capable of describing the contents of the container, designating the producer of the contents, and/or directing an end user, such as, for example, a food manufacturer, on how to use the composition in the production of a food product. According to other embodiments, the methods may further comprise shipping the container containing the composition. Any conventional method of shipping may be used, such as, for example, shipping by truck, train, ship, or plane.

The DAG oil-containing protein compositions of the present invention can be incorporated into a variety of food products, and provide the gustatory and/or organoleptic benefits of typical high-fat foods, without the negative health impacts, through use of diacylglycerol oils in place of triacylglycerol or other oils.

Formulating food products using the DAG oil-containing protein compositions of the present invention yields a variety of advantages. In addition to the health benefits associated with diacylglycerol oil consumption, the amount of saturated fat in these products can be reduced and replaced with an oil lower in saturates and higher in polyunsaturates. Products retain their flavor profile, allowing consumers to enjoy eating their favorite items without sacrificing taste.

The compositions can be used in a variety of food systems in which it is desirable to add protein and some level of fat. For instance, the compositions can be added to prepared dry mixes, baked goods (including, but not limited to, cake, muffins, brownies, bread, dough and cookies), nutritional drinks/beverages (such as, without limitation, meal replacements, energy or nutritional beverages), salad dressings, sauces, gravies, yogurt, nutritional and/or health food products (including, but not limited to, health or nutritional bars), prepared foods, food ingredients, and the like. Products formulated with diacylglycerol oil are similar in appearance, taste, and texture to their triacylglycerol oil controls, especially in the baked products with higher fat content.

Any food product made with protein and fat components can benefit from the use of the compositions of the present invention. Food and drink products contemplated within the scope of the present invention may also benefit, in the sense of appeal to the consumer's palate, from a higher fat content.

The present invention may be further understood by reference to the following examples. The following examples are merely illustrative of the invention and are not intended to be limiting. Unless otherwise indicated, all parts are by weight.

### EXAMPLES

### Example 1

### A Protein-DAG Oil Composition from a Soy Manufacturing Process

Soy whey, soy curd, protein concentrate or protein liquor from a soy protein isolation process can be used. DAG oil is added to the neutralized protein stream, and the material mixed for 5 minutes. Once the DAG oil is incorporated, the material can be spray dried. Alternatively, the combined protein-DAG oil mixture can be jet-cooked, flash-cooled, homogenization and spray-dried. The material can be optionally ground and screened or agglomerated.

### Example 2

### A Protein-DAG Oil Composition from a Protein Powder

PRO-FAM® 873 is hydrated in 50° C. water for 15-20 minutes. DAG oil is then added and the combined materials are mixed for 5 additional minutes. The material is then subjected to HTST (High Temperature Short Time) pasteurization at 85°-90° C. or UHT pasteurization at 110°-140° C. with two stage homogenization at 2500/500 psi. The resultant material is flash-cooled under vacuum or through the use of an indirect cooling medium. The cooled composition is then spray-dried. The material can be optionally ground and screened or agglomerated. This produces a protein-DAG oil composition containing about 30% DAG oil, about 60% protein, about 5% moisture, and about 5% ash.

### Example 3

### A Chocolate Pudding Made with a Protein-DAG Oil Composition

The following ingredients are combined:

TABLE 1
Ingredients for Chocolate Pudding

| Ingredient | % by weight |
|---|---|
| Profam-Enova Blend | 50 |
| Crystalline Fructose | 25 |
| ADM D-11-V Cocoa | 11 |
| ADM Fibersol-2 | 4.875 |
| Tri-Calcium Phosphate | 0.5 |
| Aspartame | 0.05 |
| ADM Tri-Calcium Citrate | 0.075 |
| National Starch Ultra-Sperse HV | 4 |
| National Starch N-Creamer | 1 |
| Viscarin SD 389 Carrageenan | 0.5 |
| Xanthan Gum | 0.05 |
| Locust Bean Gum | 0.05 |
| NaCl | 0.4 |
| Otten's Creamy Vanilla S-583 | 0.5 |
| OSF Masking Agent 3597 | 0.5 |
| Sensient Art. Cream Flavor 403606 | 0.5 |
| Cocoa Buds | 1 |
| Total | 100 |

After the ingredients are combined, the mixture is packaged, e.g., in pouches of 50.0 grams. The contents of one pouch can be reconstituted, for example, in approximately 100 grams of cold water in a bowl, and mixed using a electric hand mixer until thick (2-3 minutes).

### Example 4

### Powdered Vanilla Shake Mix Made with a Protein-DAG Oil Composition

The following ingredients are combined:

TABLE 2
Ingredients for Powdered Vanilla Shake Mix

| Ingredient: | % by weight |
|---|---|
| ADM ProFam-Enova Blend | 38.5 |
| ADM Cornsweet Crystalline Fructose | 27 |
| Aspartame | 0.15 |
| ADM Fibersol-2 | 14 |
| ADM Clintose CR10 Maltodextrin | 8.02 |
| ADM Soy Beverage Enrichment-SF | 3 |
| Buddenheim Micronized TCP | 1.5 |
| ADM Xanthan Gum | 0.4 |
| Degussa Viscogum BE Locust Bean Gum | 0.4 |
| FMC SD 389 Carrageenan | 0.13 |
| ADM Ultralec P deoiled lecithin | 0.2 |
| NaCl | 0.3 |
| Mission Masking Agent L-7301 | 2.25 |
| David Michaels Nat. Cream Flav #535 | 1.8 |
| David Michaels Art. French Vanilla #2799 | 0.8 |
| David Michaels N&A Creamy Vanilla | 1.1 |
| #1398 | |
| David Michaels Nat. #2445 Butterscotch | 0.45 |
| TOTAL | 100 |

After the ingredients are combined, the mixture is packaged, e.g., in pouches of 45.0 grams. The contents of one pouch can be reconstituted, for example, in 8 oz. of water.

### Example 5

### Powdered Chocolate Milk Shake Mix Made with a Protein-DAG Oil Composition

The following ingredients are combined:

TABLE 3
Ingredients for Powdered Chocolate Milk Shake Mix

| Ingredient: | % by weight |
|---|---|
| ADM Pro-Fam-Enova Blend | 35.000 |
| ADM Crystalline Fructose | 33.000 |
| Aspartame | 0.150 |
| ADM Fibersol-2 | 14.000 |
| ADM D-11-V Cocoa | 9.435 |
| Buddenheim Tri-Calcium Phosphate | 1.500 |
| ADM Soy Beverage Enrichment SF | 3.000 |
| ADM Xanthan Gum | 0.175 |
| Degussa Viscogum BE Locust Bean Gum | 0.175 |
| FMC SD 389 Carrageenan | 0.130 |
| ADM Deoiled Lecithin | 0.200 |
| NaCl | 0.885 |
| Sensient Creamy Shake 2019645 | 1.000 |
| David Michael N&A Milk Choc. 1124 | 1.350 |
| Total | 100.000 |

After the ingredients are combined, the mixture is packaged, e.g., in pouches of 48.0 grams. The contents of one pouch can be reconstituted, for example, in 8 oz. of water.

### Example 6

### Sugar-Free Powdered Vanilla Shake Mix Made with a Protein-DAG Oil Composition

The following ingredients are combined:

TABLE 4
Ingredients for Sugar-Free Powdered Vanilla Milk Shake Mix

| Ingredient: | % by weight |
|---|---|
| ADM ProFam-Enova Blend | 40.0 |
| ADM 10 DE Clintose Maltodextrin | 28.9 |
| Sucralose | 0.20 |
| ADM Fibersol-2 | 19.0 |
| ADM Soy Beverage Enrichment-SF | 4.10 |
| Buddenheim Micronized TCP | 0.227 |
| ADM Xanthan Gum | 0.35 |
| Degussa Viscogum BE Locust Bean Gum | 0.35 |
| FMC SD 389 Carrageenan | 0.15 |
| NaCl | 0.30 |
| Mission Masking Agent L-7301 | 2.25 |
| David Michaels Nat. Cream Flav #535 | 1.8 |
| David Michaels Art. French Vanilla #2799 | 0.8 |
| David Michaels N&A Creamy Vanilla | 1.1 |
| #1398 | |
| David Michaels Nat. #2445 Butterscotch | 0.45 |
| TOTAL | 100.0 |

After the ingredients are combined, the mixture is packaged, e.g., in pouches of 30.0 grams. The contents of one pouch can be reconstituted, for example, in 8 oz. of water.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method of making a protein composition containing DAG oil, comprising:
combining:
(i) a liquid protein-containing ingredient; and
(ii) a DAG oil;
to form a liquid protein-oil mixture; and
spray-drying the liquid protein-oil mixture;
thereby making a protein composition containing DAG oil.

2. The method of claim 1, further comprising hydrating a protein powder to make the liquid protein-containing ingredient.

3. The method of claim 2, where the protein powder is hydrated under conditions of high shear.

4. The method of claim 2, where the protein powder is hydrated for about 10 to about 15 minutes.

5. The method of claim 1, further comprising pasteurizing the liquid protein-oil mixture before spray-drying.

6. The method of claim 5, further comprising, before spray-drying, flash cooling the pasteurized liquid protein-oil mixture under vacuum.

7. The method of claim 1, wherein the protein is selected from the group consisting of: animal protein, plant protein and mixtures thereof.

8. The method of claim 7, wherein the animal protein is selected from the group consisting of: milk protein, caseinate, whey protein, buttermilk solids, milk powders, egg protein and mixtures thereof.

9. The method of claim 7, wherein the plant protein is selected from the group consisting of: soy, canola, pea, wheat, potato, corn, sesame, sunflower, cottonseed, copra, palm kernel, safflower, linseed, peanut, lupin, edible bean, oat, and mixtures thereof.

10. The method of claim 1, wherein the protein composition contains up to about 50% DAG oil by weight.

11. The method of claim 1, wherein the protein composition contains about 50% to about 80% protein by weight.

12. The method of claim 1, wherein the liquid protein-oil mixture contains about 70% protein isolate and about 30% DAG oil by dry weight.

13. The method of claim 1, wherein the protein composition contains about 60% protein by weight.

14. A protein composition containing DAG oil, made by the method of claim 1.

15. A protein composition containing DAG oil, made by a method comprising:
combining:
(i) a liquid protein-containing ingredient; and
(ii) a DAG oil;
in amounts necessary to produce a liquid protein-oil mixture that is about 50% to about 80% protein by dry weight and about 20% to about 50% DAG oil by weight; and
spray-drying the liquid protein-oil mixture;
thereby making a protein composition containing DAG oil.

16. The protein composition of claim 15, wherein the liquid protein-oil mixture comprises about 30% DAG oil by weight and about 70% protein-containing ingredient by dry weight.

17. The protein composition of claim 15, wherein the protein composition contains about 60% protein by weight.

18. A dried composition consisting essentially of protein and DAG oil.

19. A dried composition comprising protein and DAG oil.

20. A dried composition comprising about 50% to about 80% protein by weight, and up to about 50% DAG oil by weight.

21. A dried composition comprising about 60% protein by weight, and about 30% DAG oil by weight.
